(19) United States
(12) Patent Application Publication
(10) Pub. No.: US 2026/0188963 A1
(43) Pub. Date: Jul. 2, 2026

(54) SYSTEM AND METHOD FOR THERMAL MANAGEMENT OF A LASER SYSTEM

(71) Applicant: Applied Materials Israel Ltd., Rehovot (IL)

(72) Inventors: Tamar YELIN, Rehevot (IL); Micha NIXON, Sitria (IL)

(21) Appl. No.: 19/007,268

(22) Filed: Dec. 31, 2024

(51) Int. Cl. H01S 3/04

(52) U.S. Cl. CPC H01S 3/0405

(57) ABSTRACT

A system and method for thermal management of an optical system. The system comprises at least one laser unit configured for operating in periods of at least a first high power output mode and a second low power output mode, an optical arrangement configured for receiving output beam of the at least one laser unit and for directing the input beam for generating at least one illumination spot having at least one of a selected spot location and selected spot parameters, and a thermal management system. Wherein the thermal management module is configured and operable for maintaining increased thermal conditions of the optical arrangement when the at least one laser unit is in the second low power output mode.

### TECHNOLOGICAL FIELD

The present disclosure relates to thermal management of laser systems, and specifically relates to thermal management of laser systems having corresponding optical arrangement.

### BACKGROUND

Laser-based optical systems are integral to numerous applications, including material inspection and processing, medical procedures, communication, and scientific research. In these systems, maintaining the precision and quality of the laser beam's illumination spot during operation is crucial for performance, reliability and reproducibility. One significant challenge in achieving this precision is managing the thermal effects within the system.

Generally, when lasers operate, they generate heat due to inefficiencies in the conversion of electrical power into light. This heat can cause various components of the optical system, including laser diodes, optical lenses, and mirrors, to change temperature. These temperature changes can lead to variation in one or more parameters of output beam and an illumination spot generated therefrom.

For example, heat can also cause mechanical components within the laser system to expand or contract, leading to misalignment of optical elements. This misalignment can shift the laser beam from its intended path, known as beam drift, which impacts the accuracy and consistency of the laser spot. Additionally, the wavelength of laser light can shift with temperature changes due to the altered electronic properties of the lasing material. Since many optical systems are sensitive to wavelength, such shifts can affect the focus and intensity of the laser spot and interfere with the system's performance.

The conventional techniques for mitigating thermal effects often relate on cooling to the laser unit and/or associated optical arrangement. Various active cooling techniques such as the use of fans, thermoelectric coolers (TECs), liquid cooling systems, etc., are able to extract heat to cool the system and typically operate using a defined target temperature of the laser and optical components, thereby minimizing prolonged thermal effects following stabilization of the laser's operation. In other techniques, certain elements are designed to be thermally isolated to minimize heat transfer or produced using material having low thermal expansion.

### GENERAL DESCRIPTION

There is a need in the art for novel techniques enabling thermal management of laser systems and corresponding optical arrangements for maintaining desired illumination parameters. More specifically, when the operation power of the laser system varies, e.g., switching laser on or changing between laser power modes, each of the laser modes may have different thermal conditions and corresponding stabilization times. The illumination parameters may differ depending on the thermal conditions, resulting in unstable illumination conditions during thermal stabilization time, as well as different illumination conditions for different power levels. The technique of the present disclosure provides for reducing the effect of thermal stabilization time on the illumination parameters and/or reducing the thermal stabilization time required for the different illumination parameters.

In some applications, a laser unit may be operating in two or more different operation modes, and switch between the operation modes during a selected process. Such two or more different operation modes may differ in level of heat transmitted/radiated from the laser unit toward an associated optical arrangement, resulting in change in thermal conditions of the optical arrangement when switching between operation modes of the laser unit.

While active cooling may be used to maintain thermal conditions, it may often require additional space complexity, and costs. The rising demand for miniaturization and increase in complexity of various systems often limits the available space, requiring additional thermal management techniques.

The technique of the present disclosure provides thermal management of the laser unit to enable (i) shortening of stabilization time for illumination parameters when switching operation modes of the laser unit; (ii) reducing variation in beam parameters associated with different operation modes of the laser unit; or a combination of the two.

Accordingly, the present disclosure provides a system and corresponding method for thermal management of an optical laser system in which a laser unit operates with at least two different operation modes. For example, the laser unit may operate with a period of high power (e.g., active lasing, or increased power) mode and a period of low power mode. In some cases, the laser unit may operate to emit an illumination beam having low power during the second low power mode. Alternatively, the second low power mode may be an idle mode of the laser unit. In some configurations the laser unit may operate in three or more different power modes, where for simplicity the present disclosure relates to first and second mode. Generally, the technique of the present disclosure may be extended to three or more modes, dealing with each mode switching as a transition between two modes and adjusting thermal properties accordingly.

The technique of the present disclosure generally utilizes maintaining increased thermal conditions of at least an optical arrangement associated with the laser unit. By maintaining increased thermal conditions of the optical arrangement, the present technique enables maintaining one or more beam and illumination spot parameters, thus enhancing reliability and reproducibility of location and/or spot size of the laser illumination. In this connection, the term maintaining increased thermal conditions relates to maintaining thermal conditions increased with respect to steady state thermal conditions associated with the low power operation (or idle) mode of the laser unit. The increased thermal conditions are closer to or similar to the steady-state thermal conditions that correspond to the first-high power mode. This provides for increased stabilization rate of the optical arrangement to the steady state temperature associated with the high-power operation mode of the laser.

Thus, according to a first broad aspect, the present disclosure provides a system comprising: at least one laser unit configured for operating in periods of at least a first high power output mode and a second low power output mode; an optical arrangement configured for receiving output beam of the at least one laser unit and for directing the input beam for generating at least one illumination spot having at least one of selected spot location and selected spot parameters; and a thermal management system; wherein the thermal management module is configured and operable for maintaining increased thermal conditions of the optical arrangement when the at least one laser unit is in the second low power output mode. Operation of the thermal management is directed to reduce stabilization time of the laser unit and the system. Generally, the thermal management module is configured to control heat coupling between the at least one laser unit and the respective optical arrangement, providing heat conduction between the laser and the optical arrangement.

According to some embodiments, the second low power output mode is an idle mode of the at least one laser.

According to some embodiments, the thermal management module is configured for operating the at least one laser unit below the lasing threshold when in the idle mode, and for coupling heat between the at least one laser unit and the optical arrangement to maintain increased thermal conditions of the optical arrangement during the idle mode operation period of the at least one laser unit.

According to some embodiments, the thermal management module is configured for operating the at least one laser unit in an inefficient lasing mode when in said second low power output mode, thereby generating excess heat for maintaining increased thermal conditions of the optical arrangement prior to switching the laser to the first high power output mode.

According to some embodiments, the thermal management module is configured for operating the laser unit at an increased output power, producing increased excess heat, and for coupling the excess heat toward the optical arrangement.

According to some embodiments, the system may further comprise a thermo-electric cooling (TEC) module configured for transferring heat from the at least one laser unit to the optical arrangement for maintaining the increased thermal conditions of the optical arrangement when the at least one laser unit is in the second low power output mode.

According to some embodiments, the thermal management module comprises at least one heater element configured for heating at least a portion of the optical arrangement to thereby maintain increased thermal conditions thereof.

For example, according to some embodiments, the thermal management module may operate the laser unit at an extra high power output mode for a selected duration associated with thermal stabilization time, thereby enhancing heating of the optical arrangement and reducing stabilization time.

According to some embodiments, the at least one heater comprises at least one electrical resistor.

According to some embodiments, the thermal management module comprises a cooling arrangement configured for cooling the at least one laser unit and the optical arrangement, and wherein the thermal management module is configured for switching between high and low cooling mode, such that the cooling arrangement operates at low cooling mode when during operation of the at least one laser unit in the second low power output mode to maintain increased thermal conditions of the optical arrangement. In some embodiments, the thermal management module may maintain operation at the low cooling mode for a selected duration after switching of the laser unit to the first high output power mode, to reduce thermal stabilization time.

According to some embodiments, the operation of the thermal management system is synchronized with operation modes of the at least one laser unit. The operation of the thermal management unit may be delayed from switching operation mode of the laser unit. In this connection, the term ‘synchronized’ as used herein may relate to time operation that may be directly aligned or shifted by a selected period (similar to a phase shift).

According to some embodiments, the thermal management module comprises at least one processor and memory circuitry and is configured and operable for receiving and processing laser operation data indicative of operation of the at least one laser unit in the first high power output mode and the second low power output mode. The thermal management module may obtain sensing data indicative of one or more of: spot location, beam parameters, laser operation parameters, temperature data from one or more sensors, etc. The thermal management may be associated with one or more thermal sensors, optical sensors, and/or be configured to obtain operation data from the laser unit.

According to some embodiments, the thermal management module is configured and operable for heating at least a portion of the optical arrangement during operation of the at least one laser unit in the second low power output mode. In some embodiments the thermal management module may maintain heating at least a portion of the optical arrangement for a selected duration after switching of the laser to the first high output power mode, to reduce thermal stabilization time.

According to some embodiments, the parameters of the at least one illumination spot comprise at least one of spot size and spot location, polarization, intensity profile, transmission, wavefront profile contrast.

According to a second broad aspect, the present disclosure provides a method for thermal management of an optical laser system comprising at least one laser unit operating in periods of at least a first high power output mode and a second low power output mode, and an optical arrangement; the method comprising: operating a thermal management module for maintaining increased thermal conditions of the optical arrangement during period when the at least one laser unit is in the second low power output mode to maintain increased thermal conditions of the optical arrangement.

According to some embodiments, operating the thermal management module for maintaining increased thermal conditions of the optical arrangement comprises operating at least one thermo-electric cooling (TEC) module for transferring heat from the at least one laser unit to the optical arrangement when the at least one laser unit is in the second low power output mode.

According to some embodiments, operating the thermal management module for maintaining increased thermal conditions of the optical arrangement comprises heating at least a portion of the optical arrangement.

According to some embodiments, operating the thermal management module for maintaining increased thermal conditions of the optical arrangement comprises operating one or more cooling arrangements using a low cooling mode.

According to some embodiments, operating the thermal management module for maintaining increased thermal conditions of the optical arrangement comprises transmitting electrical current through one or more resistors coupled to at least one element of the optical arrangement.

According to some embodiments, the second low power output mode is an idle mode of the at least one laser unit and wherein said operating the thermal management module for maintaining increased thermal conditions of the optical arrangement comprises operating the at least one laser unit below lasing threshold when in idle mode and coupling heat between the at least one laser unit and the optical arrangement.

According to some embodiments, the method comprises operating the thermal management system in accordance with a predetermined operation protocol aligned with expected operation modes of the at least one laser unit.

According to some embodiments, the method comprises receiving input data comprising at least one of (i) data indicative of operation mode of the at least one laser, and (ii) data indicative of parameters of the at least one illumination spot and operating the thermal management system in accordance with operation mode of the at least one laser.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 schematically illustrates an optical system according to some embodiments of the present disclosure;

FIG. 2 exemplifies a method for thermal management of an optical system according to some embodiments of the present disclosure;

FIG. 3 illustrates an optical system utilizing thermal coupling between the laser unit and the optical arrangement according to some embodiments of the present disclosure;

FIG. 4 illustrates an optical system utilizing resistive heating element according to some embodiments of the present disclosure;

FIG. 5 illustrates an optical system utilizing a cooling element according to some embodiments of the present disclosure;

FIGS. 6A to 6C exemplify thermal variation through time according to some embodiments of the present disclosure, FIG. 6A exemplifies conventional operation, FIG. 6B exemplifies continuous increased thermal conditions and FIG. 6C exemplifies time variation and the use of increased thermal conditions for preparing the system to desired operation scheme according to some embodiments of the present disclosure; and

FIGS. 7A and 7B show measurement results exemplifying beam spot position over time (FIG. 7A) and system temperature over time, relative to the steady state temperature (FIG. 7B) after switching laser power using conventional operation and the technique according to some embodiments of the present disclosure while using air cooling;

FIG. 8A, and 8B show measurement results exemplifying beam spot position (FIG. 8A) and system temperature relative to the steady state temperature (FIG. 8B) over time, after switching laser power using conventional operation and the technique according to some embodiments of the present disclosure; and

FIG. 9 exemplifies a variation in TEC set point and respective change of temperature of the laser body.

### DETAILED DESCRIPTION OF EMBODIMENTS

Thermal conditions of optical elements may affect physical location, orientation, refractive index and various other parameters. As a result, variation in temperature may result in respective (although at times not fully correlated) variation in one or more properties of optical beam transmitted through and/or using the optical elements.

In various applications, a laser unit may be operated in two or more different operation modes including for example a first high power output mode and a second low power output mode. Generally, in the first high power output mode, the laser unit may operate to emit an output beam having selected power and thus producing certain level of heat that affects associated optical arrangement. In the second low power output mode the laser unit may be idle (i.e., not emitting an output beam) or operable for emitting a low power output beam. Accordingly, in the second low power output mode the laser unit generates lower level of heat to its surrounding including the associated optical arrangement.

Typically, as a result of variation in thermal output of the laser unit between the different output modes, thermal conditions of the surrounding, and specifically of an optical arrangement typically used to direct the emitted beam, may change. Variation of thermal conditions of the optical arrangement may result in change in different parameters of the output beam, affecting reproducibility of illumination conditions. Such parameters may include the position, size and shape of the illumination spot, as well as intensity and intensity profile, polarization and wavefront profile of the beam or illumination spot. It should be understood that to obtain reliable and reproducible performance, it is desired to maintain constant and expected beam and illumination spot parameters. Further, in some cases, where illumination conditions are changed during operation, reduce stabilization time may shorten the respective operation saving time and operation costs.

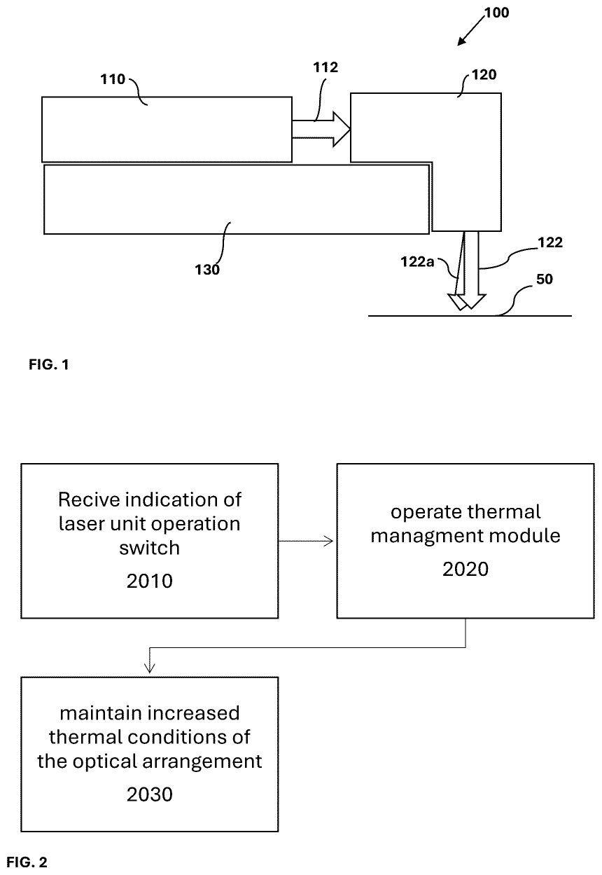

Reference is made to FIG. 1, illustrating an optical system including at least one laser unit 110 and an optical arrangement 120. The laser unit 110 is configured to emit an illumination beam 112 (of any selected wavelength including e.g., infrared, visible illumination, UV, X-ray etc.) toward the optical arrangement 120, which in turn may provide certain optical manipulation to the beam and direct an output beam 122 toward a selected surface 50. The optical arrangement 120 may include one or more optical elements including e.g., one or more lenses, reflecting surface(s), diffractive optical element(s), or any other optical element used for selected manipulation on the illumination beam 112.

Additionally, the at least one laser unit 110 is configured to operate with at least a first high power output mode and a second low power output mode. More specifically, the at least one laser unit 110 may operate at a selected (high) power for certain time. After a certain time the laser unit 110 may be turned off (zero power, without emission of illumination beam 112), or operate at a second lower output power while emitting an illumination beam 112 having lower power with respect to beam emitted in the first mode. Following the low (or zero) power output mode, the laser unit 110 may return to operate at the first high power output mode.

When the laser unit 110 operates at its first high power output mode, the emitted beam 112 and general operation of the laser unit 110 may release heat and thus increase temperature of at least a part of the optical arrangement 120. When the laser unit 110 operates in the second low power output mode (e.g., zero power, idle mode), temperature of the optical arrangement may decrease in accordance with environmental temperature. Accordingly, as the laser unit 110 switches back to the first operation mode, the optical arrangement might be relatively cold and increase its temperature during operation time of the laser in the first mode. As a result, certain parameters of the output beam 122 may vary from the “cold” state to a desired “working” state, e.g., resulting in beam 122a, or in variation in one or more other beam parameters. With operation time of the laser unit at the first mode, the temperature of the optical arrangement rises, and the beam 122 may return to the desired beam parameters. Such beam parameters may include one or more of location of an illumination spot on the surface 50, size of the illumination spot, illumination profile distribution within the spot, or any other parameter than defines the output beam and/or illumination spot.

The present disclosure thus provides a technique, generally utilizing a thermal management module, for adjusting thermal conditions of the optical arrangement for mode switching of the at least one laser unit. The present technique may be used to provide fast recovery of the output beam by eliminating, or at least reducing stabilization time of beam parameters as the optical arrangement heats with the increased power output of the at least one laser unit 110. In some embodiments, the present disclosure provides fast recovery of the output beam by reducing difference in beam parameters between first high power output mode and second low power output mode of the at least one laser unit. Generally, in some embodiments the present disclosure may provide for both the above-described objectives.

To enable fast recovery of the output beam 122, the present disclosure utilizes a thermal management system 130. The thermal management system is configured for maintaining increased thermal conditions of the optical arrangement 120, for at least a portion of time period in which the at least one laser unit 110 is operated in its second low power output mode. By maintaining increased thermal conditions of the optical arrangement 120, the thermal management system 130 enables fast recovery of the optical system 100 to provide output beam 122 with desired, stable, and reproducible beam parameter. This may enable operation of the laser unit 110 with periods of first and second operations modes, while eliminating, or at least significantly reducing, beam re-stabilization time after switching between second operation mode to first operation mode. For example, the thermal management module may operate to cause the at least one laser unit to generate excess heat while in the second low output power mode, and to couple the excess heat to the optical arrangement. Such excess heat may be generated when the laser unit 110 is in idle mode, i.e., not emitting an output beam, or when the laser unit 110 emits a low power output beam.

The thermal management module 130 may be implemented in various configurations and operational modes selected in accordance with configuration of the laser unit 110 and optical system 120. For example, in some configurations, the laser unit 110 may be associated with a thermo-electric cooling (TEC) module, configured for cooling elements of the laser unit 110 by transmitting heat out of the laser unit. According to some embodiments of the present disclosure, the TEC module may be configured to transmit heat evacuated from the laser unit 110 toward the optical arrangement 120. Operation of the TEC may be maintained while the laser unit 110 is in second (lower) output power mode, including cases when the laser unit is in idle mode, to maintain increased temperature of elements of the optical arrangement. For example, a set-point of the TEC module may be adjusted, or varied, between laser operation in first and second power modes, to couple additional heat to the optical arrangement during second mode operation of the laser unit.

Certain additional sources for maintaining increased thermal conditions of the optical arrangement may include operating the at least one laser unit 110 below lasing threshold, while in idle (e.g., second) mode, and transmitting/coupling so-generated heat toward the optical arrangement.

In some further configurations, the thermal management module 130 may utilize one or more heating elements configured to selectively heat at least a portion of the optical arrangement. Such heating elements may include one or more electrical resistors, or other electrical heaters thermally coupled to at least a part of the optical arrangement 120 to transfer heat thereto.

Alternatively, certain systems may utilize a cooling arrangement for cooling the at least one laser unit 110 and the respective optical arrangement 120. To maintain thermal conditions while the at least one laser unit 110 shifts between first and second modes of operation, thereby varying the amount of heat generated thereby, the cooling arrangement may be configured to switch between high cooling mode while the at least one laser unit 110 operates at a first high output power mode, and low cooling mode when the at least one laser unit 110 operates at second lower output power mode. The term “low cooling’ may relate to reduced operation of a cooling arrangement or switching operation of the cooling arrangement off to stop cooling. In some embodiments, the thermal management module may include one or more temperature sensors positioned to generate temperature data indicative of environmental temperature on one or more elements of the optical arrangement. The thermal management module may be configured to operate the cooling arrangement in accordance with data on temperature. For example, the thermal management module may pause cooling operation if temperature of elements of the optical arrangement goes below a selected threshold, and restart operation of the cooling arrangement in accordance with increase of temperature above a selected working threshold. In some embodiments, pausing temperature threshold may be determined as a first pause threshold associated with first high output power mode of the laser unit, and a second pause threshold associated with the second low output power mode of the laser unit.

Further, in some embodiments, the thermal management module 130 may be associated with one or more optical sensors providing data indicative of one or more optical parameters of output beam 122 and/or so generated illumination spot. The one or more optical sensors may provide data indicative of optical parameters, indicating stabilization of the output beam.

Additionally, the thermal management module 130 may also be associated with a clock or a time piece, providing data indicative of a duration between selected actions or input signal of the system. Accordingly, the thermal management module may determine the switching between operation modes of the laser in accordance with one or more signal types including a selected duration signal (time signal), thermal data obtained from a temperature sensor indicating that temperature reaches a selected value (thermal signal), and/or data obtained by the one or more optical sensors indicating parameters of the beam/illumination spot being desired or undesired parameters (optical signal). In some embodiments, operation of the thermal management module 130 may be synchronized with operation modes of the laser unit 110. Such synchronization may be associated with switching time of the laser unit 110, and may include a time delay between switching operation of the laser unit and operation of the thermal management module.

For example, in some embodiments, the thermal management module 130 may be operated to heat or avoid cooling of the optical arrangement 120 and optionally of the laser unit when the laser unit 110 is in the second low output power mode (or idle). Upon switching the laser unit to the high output power mode, the thermal management module 130 may continue heating (or avoid cooling) the optical arrangement 120 and/or the laser unit 110, until temperature is within selected range from stabilized operation temperature. In some configurations, the thermal management module 130 may also operate the laser unit 110 at extra high output power mode, to produce excess heating and thus reduce time required for stabilization.

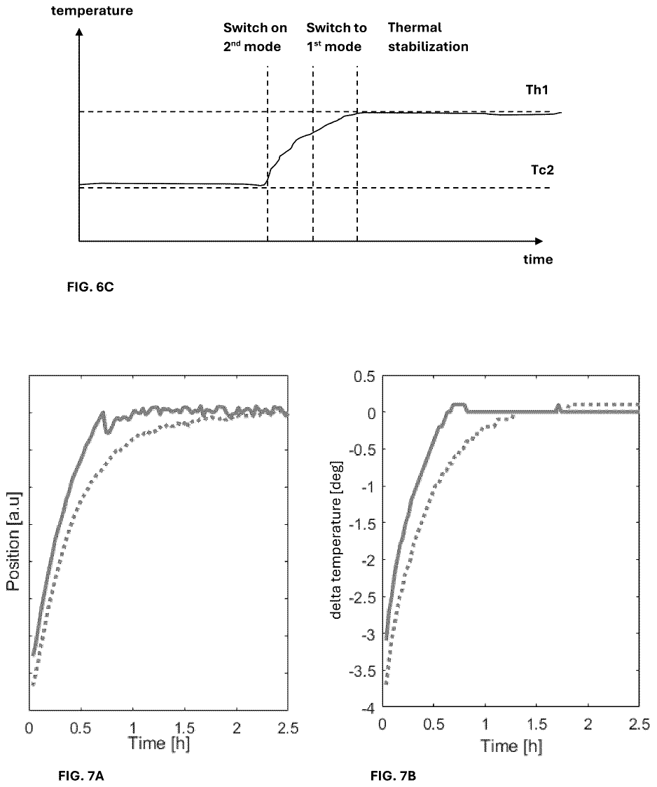

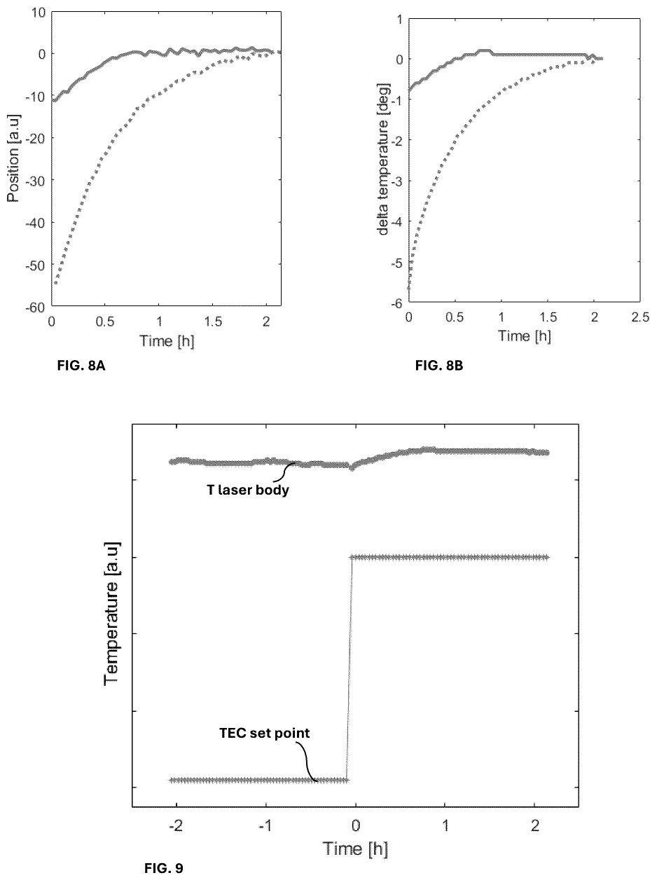

As exemplified below, with reference to FIGS. 7A to 7B and FIGS. 8A to 8C, a variation in thermal conditions of the optical arrangement may result in change in various illumination parameters. This includes for example parameters such as location of an illumination spot, size of the illumination spot, profile of the illumination spot etc. typically, following switching of an operation mode of the laser unit 110 the thermal conditions of at least one of the laser unit and optical arrangement vary and certain stabilization time is needed until the desired illumination parameters stabilize when the temperature of the optical arrangement reaches a stable working temperature, and the illumination spot reaches the desired “zero” location on the target surface. This variation in location of the illumination spot may require a system or its operator to wait for certain relaxation time, until the laser unit and optical arrangement settle to working temperature and the illumination spot reaches the desired location.

To reduce the time required between change in laser operation mode, between the first (high power) mode and the second (low power, or idle) mode, the technique of the present disclosure operates to maintain increased thermal conditions of the optical arrangement, while the at least one laser unit is in second (low power or idle) mode. Maintaining increased thermal conditions of the optical arrangement eliminates, or at least significantly reduces the time required for the optical arrangement to heat up in response to higher power output provided by the at least one laser unit and provide desired parameters of the illumination beam transmitted through the optical arrangement.

In this connection, FIG. 2 illustrates main actional associated with a method according to some embodiments of the present disclosure. As illustrated, the method includes receiving an input indication on switching operation mode of at least one laser unit 2010. Following the indication of switching operation mode of the laser unit, the method includes operating the thermal management module accordingly 2020. Operation of the thermal management module is directed at maintaining increased thermal conditions of the optical arrangement 2030.

In this connection, the thermal management module 130 may be configured to receive input signal indicating on mode switching of the at least one laser unit 110 Alternatively, or additionally, the thermal management module 130 may be connected in series or parallel as the at least one laser unit 110, such that a common signal switching operation mode of the laser unit, acts as an input signal to the thermal management unit 130. Further, in some embodiments, the at least one laser unit 110 may operate for switching between the first and the second modes of operation in accordance with a predetermined time setting, e.g., in accordance with a clock. The thermal management module 130 may be operable with a common clock signal to maintain increased thermal conditions of the optical arrangement when the laser unit is in the second (lower output or idle) mode.

Typically, maintaining an increased thermal condition of the optical arrangement relates to preventing cooling of the optical arrangement to a level that will affect output beam parameters. In some embodiments, the technique of the present disclosure may operate to maintain temperature of one or more optical elements of the optical arrangement at the temperature measured during the first (high output power) operation mode of the laser unit.

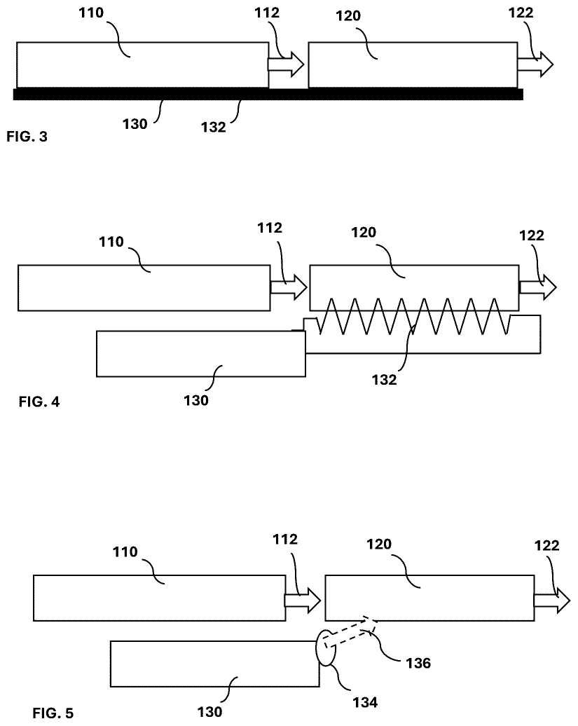

Reference is made to FIGS. 3, 4 and 5 schematically exemplifying selected embodiments of the present disclosure. FIG. 3 illustrates an optical system including at least one laser unit 110, an optical arrangement 120 and a thermal management module 130 using heat conducting element 132 coupled between the at least one laser unit 110 and the optical arrangement. FIG. 4 illustrates a generally similar system, where the thermal management module 130 utilizes a resistor heating element 132 for maintaining increased thermal conditions of the optical arrangement 120. FIG. 5 illustrates an optical system including a cooling arrangement 134.

In the Example of FIG. 3, the at least one laser unit 110 and the optical arrangement 120, or at least a part of the optical arrangement 120, are coupled via a thermally conducting element 132. This configuration enables transmission of heat generated by the laser unit 110 toward the optical arrangement 120 to maintain increased thermal conditions of the optical arrangement 120.

Various laser units utilize a thermo-electric cooling (TEC) module for cooling one or more parts of the laser unit, typically the diode. The TEC is configured to transmit heat from a cold side (act for cooling) toward a hot side thereof. As exemplified in FIG. 3 the hot side of the TEC may be coupled, e.g. using a thermal conducting plate 132, to at least a part of the optical arrangement 120 to transmit heat to the optical arrangement. The thermal management module 130 may be configured to adjust TED parameters to keep it operating while the laser is in the second (low power or idle) mode, and to maintain heat transmission to the optical arrangement 120. For example, the TEC set point may be adjusted to provide additional cooling to the laser unit 110 when operated in the second mode, and to thereby transmit additional heat to the optical arrangement 120 and maintain its increased temperature when the laser unit operates in idle mode or using lower output power.

In some additional configurations, which may also apply to the example of FIG. 3, the thermal management module 130 may be associated with operation of the at least one laser unit 110. For example, in some embodiments, the second operation mode of the laser unit may relate to idle mode, where no output beam is emitted. In this example the thermal management module 130 may be a part of general management module of the laser unit 110 and may operate the laser unit 110 to maintain current transmission therethrough. The current transmission passed through the laser unit 110 when it is in idle mode is selected to be below lasing threshold. This current may result in generation of heat by the laser unit 110, while avoiding emission of an output beam 112. The excess heat is coupled via the thermal conducting plate 132 to the optical arrangement 120 to maintain increased thermal conditions thereof. Additionally, or alternatively, the second operation mode of the laser unit 110 may be an inefficient lasing mode. Generally, inefficient laser operation can be achieved in various techniques including e.g. thermal detuning of the laser optical components from optimal conditions, opto-mechanical detuning to increase losses within the laser, or attenuating within the laser system. In addition, an inefficient mode can be achieved by operating the laser at an increased laser power, typically higher than the required power. Excess power can be attenuated or handled by managing the illumination conditions. When operating in an inefficient mode, the laser unit 110 generates heat, while output emission may be reduced or blocked.

According to some embodiments of the present disclosure, the thermal management module 130 may operate in one or more operation schemes in accordance with operation requirements and applications of the system. In some embodiments, the at least one laser unit 110 may be operated in a first high output power mode, and one or more third low output modes, and the second low output mode relates to a dedicated non-efficient mode, in which the at least one laser unit 110 generates excess heat. The thermal management module 130 couples excess heat generated by the laser unit 110 to at least a part of the optical arrangement 120, thus increasing the temperature of elements of the optical arrangement prior to switching the laser unit 110 to the first high output power mode. Generally, the optical system 100 and the respective thermal management module may be configured to switch the laser 110 operation to the second mode for a predetermined duration, or for a duration selected in accordance with thermal conditions of the optical arrangement, to bring the optical arrangement to desired thermal conditions. After a selected duration of operation in second mode, the optical system 100 may switch the laser unit 110 to first high output power mode providing desired beam parameters. The thermal management module 130 may utilize one or more thermal sensors for determining a suitable duration of operation in the second mode.

Further, in configuration utilizing TEC module for cooling selected elements of the laser unit 110 and/or the TEC module may be adjusted between different modes of operation of the laser unit 110. In some embodiments, a set-point of the TEC module may be adjusted to maintain heat transfer toward the optical arrangement, and thus maintain increased thermal conditions thereof. TEC set point parameters may be adjusted with time to provide increased heat coupling during the entire duration of the laser operation in the second mode (or in additional modes if any). Accordingly, change in set point of the TEC module may proceed for coupling excess heat prior to switching to first high output power mode, and either return to normal set point, or maintain increased heat coupling during selected initial period of operation in the first mode.

An additional optional configuration is exemplified in FIG. 4. In this configuration, the thermal management module 130 includes an electronic circuit and at least one heater (e.g., resistors) 132 positioned in thermal contact with at least a part of the optical arrangement 120. The electronic circuit of the thermal management module 130 is configured to transmit selected electric current through the heaters 132, when the laser unit 110 is in second mode, being idle or emitting low power beam. The electric current causes the heaters 132 to generate heat, which is coupled to respective elements of the optical arrangement, maintaining increased thermal conditions of the optical arrangement 120. In accordance with specific arrangement of the optical arrangement 120, the thermal management module 130 may include a selected number of heaters 132 and operate to transmit selected one or more levels of current therethrough, to provide suitable thermal conditions of the optical arrangement 120.

Generally, the use of one or more heaters 132, can shorten the time to get the optical arrangement to desired working temperature suitable for operation of the laser unit 1120 in its first high output power mode. Accordingly, operation of the thermal management 130 may vary in accordance with various embodiments and configuration of the system. Accordingly, in some exemplary embodiments, the one or more heaters may be operated for heating one or more elements of the optical arrangement during period in which the laser unit 110 operates in a second low power output mode, to maintain increased thermal conditions of the optical arrangement. In some embodiments, the thermal management module 130 may operate to turn the one or more heaters off to stop heating to avoid over heating of the optical elements. In some further embodiments, the thermal management module 130 may maintain operation of the one or more heaters 132 in the ‘ON’ state for a selected duration after switching of the laser unit to the first high power output mode, further enhancing heating of the optical arrangement to achieve desired thermal conditions faster with respect to heating by the output beam only. The thermal management module may generate a turn off signal to the one or more heaters 132 in accordance with a selected heating time (timing signal), in accordance with thermal data collected by one or more thermal sensors (thermal signal) or in accordance with optical data on beam/spot parameters collected by one or more optical sensors (optical signal).

Generally, in some embodiments, the thermal management module 130 may operate the one or more heaters for heating at least a part of the optical arrangement in response to switching the laser unit 110 to the first high output power mode. This configuration provides enhanced heating of the optical arrangement to bring it to desired thermal conditions at a fast rate, while allowing thermal conditions to reduce temperature at other operation modes of the laser unit 110. The thermal management module may utilize one or more of time signal, thermal signal and/or optical signal, as an indication to stop operation of the one or more heaters to avoid over heating of the optical arrangement.

Furthermore, FIG. 5 exemplifies an additional optional configuration of the optical system according to some embodiments of the present disclosure. In the configuration exemplified in FIG. 5, the thermal management module 130 includes one or more cooling elements 134, configured to selectively apply cooling 136 to selected elements of the optical arrangement. The one or more cooling elements may include one or more fans, airflow ports, or other cooling elements. The thermal management module 130 is configured to reduce, or stop, operation of the cooling element(s) 134 when the laser unit 110 operates in its second mode, i.e., low output power or idle operation. Accordingly, the thermal management module 130 operates to avoid cooling of the optical arrangement 120 at times when the optical arrangement receives less energy from the laser unit 110, thereby enable maintaining of increased thermal conditions therein. In some embodiments, the thermal management module is configured for switching between high and low cooling modes. This enables the cooling arrangement 130 to operate at low cooling mode during operation of the at least one laser unit 110 in the second (low power output or idle) mode and maintain increased thermal conditions of the optical arrangement 120.

In some embodiments, the optical system may also include one or more thermal sensors, generating output data indicative of thermal conditions of one or more elements of the optical arrangement 120. The thermal management module 130 may be configured to receive thermal data from the one or more sensors, and determine level of heating, or reduced cooling, suitable to maintain thermal conditions of the optical arrangement 120. Further, in some embodiments, the optical system may utilize one or more optical sensors (e.g., a camera sensor) configured for monitoring one or more parameters of an illumination spot generated by the optical system 100. One or more processors of the thermal management module 130, or other management module associated with the system, may be configured to receive data on variation in one or more optical parameters of the illumination spot, and operate the thermal management module accordingly, to eliminate, or at least significantly reduce, duration of settlement/relaxation time between switching mode of the laser unit, and illumination spot having the desired optical parameters. As indicated above, the optical parameters may include one or more of illumination spot location, size, shape of the spot along one or more axes, spot symmetry, profile of the illumination spot intensity along one or more axes, etc.

Generally, the thermal management module 130 may operate the one or more cooling elements 134 in accordance with one or more selected schemes as described above. For example, in some embodiments, the thermal management module may maintain the one or more cooling elements turned off while the laser operates in the second low output power mode. When the laser unit 110 switches to the first high power output mode, the thermal management module may keep the one or more cooling elements turned off for a selected time and turn the one or more cooling elements 134 on in response to one or more of time signal, thermal signal and/or optical signal as described above. This scheme may provide fast heating of the optical arrangement and stabilization of the output beam parameters. Alternatively, the thermal management module may turn the one or more cooling elements to on state when the laser switches to the first high power output mode. This scheme maintains the temperature of the low power state closer to the temperature of the high-power state, while maintaining cooling of the optical arrangement.

In some further embodiments, the thermal management module 130 may operate the one or more cooling elements 134 for cooling respective parts of the optical arrangement and turn the one or more cooling elements to off state when the at least one laser unit 110 switches into the first high power output mode. This configuration enables increased heating and stabilization rate with respect to configurations where the cooling elements operate for cooling the optical arrangement.

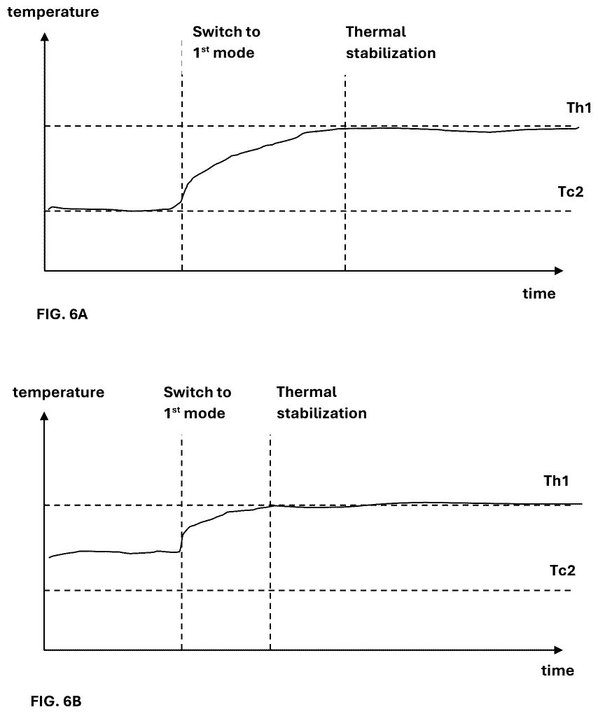

Reference is now made to FIGS. 6A to 6C exemplifying thermal conditions associated with elements of the optical arrangement along operation time according to some embodiments of the present disclosure. FIG. 6A exemplifies conventional operation scheme; FIG. 6B exemplifies maintaining increased thermal conditions according to some embodiments of the present disclosure, and FIG. 6C exemplifies mode variation and maintaining increased thermal conditions for a selected period according to some embodiments of the present disclosure.

As shown in FIG. 6A, in the conventional operation technique, the laser unit generates lower heat levels when operating in the second low power output mode, exemplified by Th2 temperature level. When the laser unit switches to the first high power output mode, the laser emits heat and the temperature of its surrounding increases. As a result, the thermal conditions of the optical arrangement increase slowly until reaching thermal stabilization at Th1 temperature after certain stabilization time. FIG. 6B exemplifies some embodiments of the present disclosure. As shown, the temperature of the optical arrangement is maintained at an increased level above relaxation level Th2, such that upon switching of the laser unit to the first high power output mode, the optical arrangement heats up and time until stabilization is reduced. As described above, in some embodiments the thermal management unit may continue operating after the laser unit switches to the first (high output power) mode. More specifically, the thermal management unit may be configured to (i) avoid cooling or (ii) provide active heating of the optical arrangement when the laser operates in the second (low power output or idle) mode. Thus, in some embodiments, the thermal management unit may keep operating when the laser switches to its first mode, for a selected period or until thermal stabilization is achieved.

An additional exemplary scheme is illustrated in FIG. 6C. In this scenario, the optical system may have one or more additional operation modes. The system may be in a third or other mode, where the optical arrangement may be allowed to cool to temperature Th2. At a selected time, the system may switch into 2nd mode. This may be associated with mode switching of the laser unit or may relate to a system operation in preparation to switch to first high power output mode. More specifically, the laser operation mode may be similar, while increased thermal conditions may be used in a selected time prior to switching to first high power output mode of the laser. Accordingly, a selected time before switching to the desired first high-power output mode, the thermal management module may determine operation in a second low power output mode, and transmit increase heat levels to the optical arrangement, increasing temperature thereof. After a selected heating time, the laser unit may switch to the first high power output mode. Due to pre-heating of the optical arrangement, and optically additional heating due to transmission of the output laser beam, thermal conditions of the optical arrangement increase with shorted time, reaching stabilization of the beam parameters. As indicated above, the effect may be reached by coupling heat generated by the laser unit, using one or more heaters and/or properly operating one or more cooling elements associated with the optical arrangement.

Further, in some embodiments, associated with the examples of FIGS. 6B and 6C, the thermal management module may switch operation of the laser unit to an extra high-power output during the stabilization time. This allows the laser unit to produce additional heat, and further increase stabilization speed. Once the temperature is sufficiently close to operation temperature (Th1), the laser may be switched back to regular first high output power mode, to provide desired illumination conditions.

It should further be noted that the thermal management module may further operate using one or more schemes for stabilizing temperature of the laser unit and optical arrangement throughout operation of the optical system. Accordingly, the thermal management module may operate for heating or cooling of the at least one laser unit and/or optical arrangement before and after reaching beam stabilization, in order to reduce the time required for beam stabilization.

Further, FIGS. 7A and 7B exemplify illumination spot position (FIG. 7A) and temperature of the laser body relative to the steady state temperature (FIG. 7B) measured over time after switching the laser to the first high output power mode following operation in Idle mode (the low power mode). The laser system in this measurement includes a thermal management module utilizing/including a cooling arrangement that is configured for cooling the at least one laser unit and the optical arrangement. The thermal management module operates for switching between high and low cooling modes (air cooling turned off in this example), effectively reducing cooling operation when the laser unit operates at a second low output power (or idle) mode and maintains low cooling operation even after switching the laser to the high output power mode, until temperature stabilization.

In FIGS. 7A and 7B, time zero represents the time at which we switch the laser from Idle (“second low mode”) to working power (“first high output power mode”). The dashed curves in FIGS. 7A and 7B show measured spot location and delta temperature (temperature difference from steady state temperature) for a system using conventional cooling management, i.e. continuous cooling operation at a constant rate. The solid curves show the performance employing a cooling toggle according to the present disclosure. More specifically, as indicated above, the cooling operation is reduced during operation in the low output power mode and is maintained reduced after switching to the high output power mode until temperature stabilizes. After stabilization time, beam output location and temperature stabilize to working conditions as the laser is operated on the same high state. Cooling operation is also switched to the regular cooling mode once the laser body temperature stabilizes or at some pre-defined set point close to the steady state conditions.

As shown in FIGS. 7A and 7B, thermal management according to the present disclosure enables reducing stabilization time of the optical system. For example, as shown in FIGS. 7A and 7B, stabilization time of the optical system relates to one or more illumination parameters such as location of the illumination spot. In this example, the stabilization time between switching of the laser to the high output power mode is reduced from about 2-2.5 hours (dashed line) to about 45 minutes (solid line). Once the temperature reached a pre-defined set point, the air cooling was switched to the high operating state, to maintain operation temperature of the laser and attached optics.

FIGS. 8A to 8C exemplify measurements of the position of the illumination spot (FIG. 8A) and temperature of the laser body relative to the steady state temperature (FIG. 8B) over time after switching the laser to the first high output power mode. Prior to switching of the laser mode, the laser was operated at a second low power mode. In these measurements the laser system utilizes a TEC unit, and the thermal management module is configured to control operation of the TEC unit by determining a TEC set point. More specifically, the thermal management module operates for switching between two TEC set points in a way that keeps the body of the laser at a selected temperature, being equal between the high output power and low output power modes of the laser.

As shown in FIGS. 8A and 8B, the thermal management provided in accordance with present disclosure enables reducing stabilization time of the optical system, illustrated in this example by position of the illumination spot. In this example, the stabilization time is reduced from about 2 hours (dashed line) without thermal management to about 45 minutes (solid line) from laser switching to high output power mode utilizing thermal management according to some embodiments of the present disclosure. Specifically, the example of FIGS. 8A and 8B utilize adjustment of the TEC set point to maintain high laser body temperature, while the laser operates at the low power mode, such that temperature of the laser body is almost the same between its operation modes. Accordingly, as seen in FIG. 8B, the beam position (the relevant beam parameter at this case) at the time of switching to the high output power mode is closer to its steady state value of the high output power mode (solid line in FIG. 8B) compared to the reference system (dashed line in FIG. 8B). The change in the TEC set point and respective temperature of the laser body are exemplified in FIG. 9 showing determined TEC set point and temperature of the laser body. As shown, slightly before t=0, the TEC set point was changed together with switching of the laser operation mode. Adjusting the TEC set point maintains the selected temperature of the laser body, while the laser generates less heat. During the first time period, when the laser is in the low output power mode, the TEC set point is lower compared to the second time period, thereby evacuating more heat to the laser body and the coupled optics. That way, the amount of heat transferred to the laser body and optics at the low laser power mode is similar to that of the high output power mode with the higher TEC set point.

Thus, the present disclosure provides an optical system and corresponding method, suitable for providing desired illumination conditions while operating at least one laser unit with at least first and second operations modes having respective first and second output power levels. To this end the technique of the present disclosure generally operates for maintaining increased thermal conditions of one or more optical elements of the optical arrangement, in accordance with thermal conditions associated with a first (high output power) mode of the laser unit.

It is to be noted that the various features described in the various embodiments can be combined according to all possible technical combinations.

It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based can readily be utilized as a basis for designing other structures, methods, and systems for carrying out the several purposes of the presently disclosed subject matter.

Those skilled in the art will readily appreciate that various modifications and changes can be applied to the embodiments of the invention as hereinbefore described without departing from its scope, defined in and by the appended claims.

1. A system comprising:
(a) at least one laser unit configured for operating in periods of at least a first high power output mode and a second low power output mode;
(b) an optical arrangement configured for receiving output beam of the at least one laser unit and for directing the input beam for generating at least one illumination spot having at least one of selected spot location and selected spot parameters; and
(c) a thermal management system;
wherein the thermal management module is configured and operable for maintaining increased thermal conditions of the optical arrangement when the at least one laser unit is in the second low power output mode.

2. The system of claim 1, wherein the second low power output mode is an idle mode of the at least one laser.

3. The system of claim 2, wherein the thermal management module is configured for operating the at least one laser unit below lasing threshold when in the idle mode, and for coupling heat between the at least one laser unit and the optical arrangement to maintain increased thermal conditions of the optical arrangement during the idle mode operation period of the at least one laser unit.

4. The system of claim 1, wherein the thermal management module is configured for operating the at least one laser unit in an inefficient lasing mode when in said second low power output mode, thereby generating excess heat for maintaining increased thermal conditions of the optical arrangement prior to switching the laser to the first high power output mode.

5. The system of claim 1, further comprising a thermo-electric cooling (TEC) module configured for transferring heat from the at least one laser unit to the optical arrangement for maintaining the increased thermal conditions of the optical arrangement when the at least one laser unit is in the second low power output mode.

6. The system of claim 1, wherein the thermal management module comprises at least one heater element configured for heating at least a portion of the optical arrangement to thereby maintain increased thermal conditions thereof.

7. The system of claim 6, wherein the at least one heater comprises at least one electrical resistor.

8. The system of claim 1, wherein the thermal management module comprises a cooling arrangement configured for cooling the at least one laser unit and the optical arrangement, and wherein the thermal management module is configured for switching between high and low cooling mode, such that the cooling arrangement operates at low cooling mode when during operation of the at least one laser unit in the second low power output mode to maintain increased thermal conditions of the optical arrangement.

9. The system of claim 1, wherein operation of the thermal management system is synchronized with operation modes of the at least one laser unit.

10. The system of claim 1, wherein the thermal management module comprises at least one processor and memory circuitry and is configured and operable for receiving and processing laser operation data indicative of operation of the at least one laser unit in the first high power output mode and the second low power output mode.

11. The system of claim 1, wherein the thermal management module is configured and operable for heating at least a portion of the optical arrangement during operation of the at least one laser unit in the second low power output mode.

12. The system of claim 1, wherein the parameters of the at least one illumination spot comprises at least one of spot size and spot location, polarization, intensity profile, transmission, wavefront profile contrast.

13. A method for thermal management of an optical laser system comprising at least one laser unit operating in periods of at least a first high power output mode and a second low power output mode, and an optical arrangement; the method comprising:
operating a thermal management module for maintaining increased thermal conditions of the optical arrangement during a period when the at least one laser unit is in the second low power output mode to maintain increased thermal conditions of the optical arrangement.

14. The method of claim 13, wherein operating the thermal management module for maintaining increased thermal conditions of the optical arrangement comprises operating at least one thermo-electric cooling (TEC) module for transferring heat from the at least one laser unit to the optical arrangement when the at least one laser unit is in the second low power output mode.

15. The method of claim 13, wherein said operating the thermal management module for maintaining increased thermal conditions of the optical arrangement comprises heating at least a portion of the optical arrangement.

16. The method of claim 13, wherein said operating the thermal management module for maintaining increased thermal conditions of the optical arrangement comprises operating one or more cooling arrangements using a low cooling mode.

17. The method of claim 13, wherein said operating the thermal management module for maintaining increased thermal conditions of the optical arrangement comprises transmitting electrical current through one or more resistors coupled to at least one element of the optical arrangement.

18. The method of claim 13, wherein the second low power output mode is an idle mode of the at least one laser unit and wherein said operating the thermal management module for maintaining increased thermal conditions of the optical arrangement comprises operating the at least one laser unit below lasing threshold when in idle mode and coupling heat between the at least one laser unit and the optical arrangement.

19. The method of claim 13, comprising operating the thermal management system in accordance with a predetermined operation protocol aligned with expected operation modes of the at least one laser unit.

20. The method of claim 13, comprising receiving input data comprising at least one of (i) data indicative of operation mode of the at least one laser, and (ii) data indicative of parameters of the at least one illumination spot, and operating the thermal management system in accordance with operation mode of the at least one laser.
